(19) United States
(12) Patent Application Publication
(10) Pub. No.: US 2006/0004977 A1
(43) Pub. Date: Jan. 5, 2006

(54) Autonomically tuning the virtual memory subsystem of a computer operating system

(76) Inventors: Joefon Jann, Ossining, NY (US); Pratap Chandra Pattnaik, Ossining, NY (US); Ramanjaneya Sarma Burugula, Croton on Hudson, NY (US)

Correspondence Address: IBM CORPORATION, T.J. WATSON RESEARCH CENTER, P.O. BOX 218, YORKTOWN HEIGHTS, NY, 10598, US

(21) Appl. No.: 10/881,508

(22) Filed: Jun. 30, 2004

(51) Int. Cl. G06F 12/00

(52) U.S. Cl. 711/170; 711/160

(57) ABSTRACT

A method, information processing system, and computer readable medium for efficiently distributing a computer system's main memory among applications running in that operating system instance. More specifically, threshold values used by a page replacement algorithm of the virtual memory manager are automatically tuned in response to the load on the memory of a computer system. One such threshold value is the lower threshold of free memory which is changed as a function of the load on the memory. For example, such a load might be represented as the number of threads that were added to a waiting queue during a defined interval of time divided by the number of clock tics in that interval. This representation is known as the thread wait rate. This rate is then compared to a target rate to determine if the lower threshold value should be changed. When the free memory space falls below the lower threshold, a page replacement daemon is used to page out memory to make more memory space available.

### CROSS-REFERENCE TO RELATED APPLICATIONS

Not Applicable

### STATEMENT REGARDING FEDERALLY FUNDED SPONSORED RESEARCH OR DEVELOPMENT

Not Applicable

### INCORPORATION BY REFERENCE OF MATERIAL SUBMITTED ON A COMPACT DISC

Not Applicable

### FIELD OF THE INVENTION

This invention pertains to the virtual memory management component of a computer operating system. More specifically, this invention pertains to the tuning of the threshold values used by any Page Replacement algorithm of the virtual memory manager of an Operating system.

### BACKGOUND OF THE INVENTION

The Virtual Memory Manager (VMM) component of an Operating System (OS) running on a machine is responsible for efficiently distributing the machine's main memory among the applications running in that OS instance. One of the primary responsibilities of a VMM is to page out the contents of a main memory block (called a “frame” or “page frame”) that is under-utilized to paging space on disk, and to re-allocate that frame to another application that needs main memory. This is typically achieved with the help of a daemon process called “Page Replacement daemon” (also called an “LRU daemon” in most UNIX operating systems).

Because the process of freeing up a frame (i.e. the act of moving its contents out to disk to make it a free frame) takes much longer than the process of allocating a free frame to a requesting application (the consumer of a free frame), the Page Replacement daemon typically starts paging out frames before the number of free frames in the OS goes down to zero, in anticipation of the need for additional free frames in the OS. The VMM can decide when to kick off the Page Replacement daemon and how many pages it should free up in each run, by using two tunable parameters min_free and max_free. The Page Replacement daemon is kicked off as soon as the number of free frames goes below min_free, and in each run it frees up enough pages so that the number of free frames at the end reaches max_free.

Currently these parameters have to be explicitly input by a system administrator in order to tune the performance of the VMM to suit the needs of the applications running in the OS. Because this tuning requires human manual input, these parameters are rarely being tuned, resulting in sub-optimal performance of the VMM, and hence of the OS. This lack of tuning translates into more cost for the IT organization.

### SUMMARY OF THE INVENTION

It is an objective of this invention to eliminate the need for the manual tuning of the VMM by a system administrator to improve system performance. An important benefit of this invention is that the OS becomes much more responsive/adaptive to the changes in its workloads. More specifically, this invention makes the tuning of VMM system parameters autonomic by automatically varying their values in response to on the changing memory load in the OS.

This invention provides a method for improving memory availability in an OS by automatically changing a parameter, known as a lower threshold, in response to the OS's memory load. More free memory space is created when the current free memory space goes below the lower threshold.

A more specific preferred embodiment of this invention provides a method for automatically tuning the memory manager of an OS by setting a lower threshold of free memory space to an initial value and automatically changing this lower threshold when the current “thread wait rate” differs from a target “thread wait rate”, where “thread wait rate” is the number of threads waiting per unit time over a specified time interval. The memory manager will then initiate an operation to make more memory space available when free memory space falls below the lower threshold.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings.

FIG. 1 shows the major subsystems of a typical computer operating system.

FIG. 2 shows the data structures used in implementing the current page replacement algorithm.

FIG. 3 shows a flow chart of the current Page Replacement algorithm.

FIG. 4 shows the data structures used in a preferred embodiment to implement dynamic autonomic tuning of the page replacement daemon.

FIG. 5 shows a flow chart of the new Page Replacement algorithm with this invention.

FIG. 6 shows how min_free and max_free will be changed by the LRU daemon with respect to time.

FIG. 7 is a diagram of an illustrative hardware implementation of a computing system in accordance with which one or more components/methodologies of the present invention may be implemented.

### DETAILED DESCRIPTION

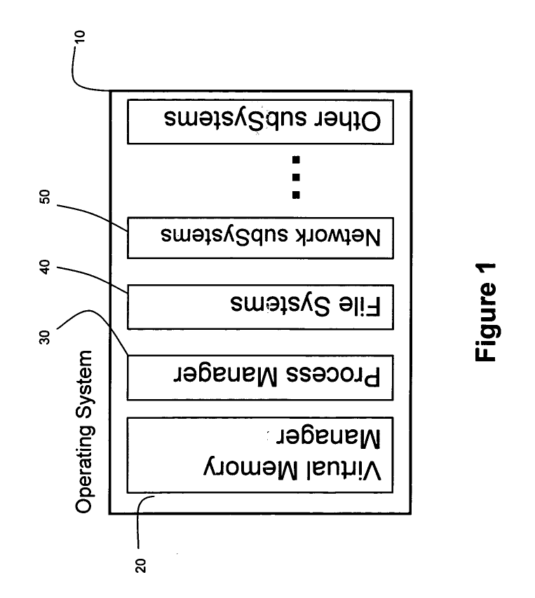

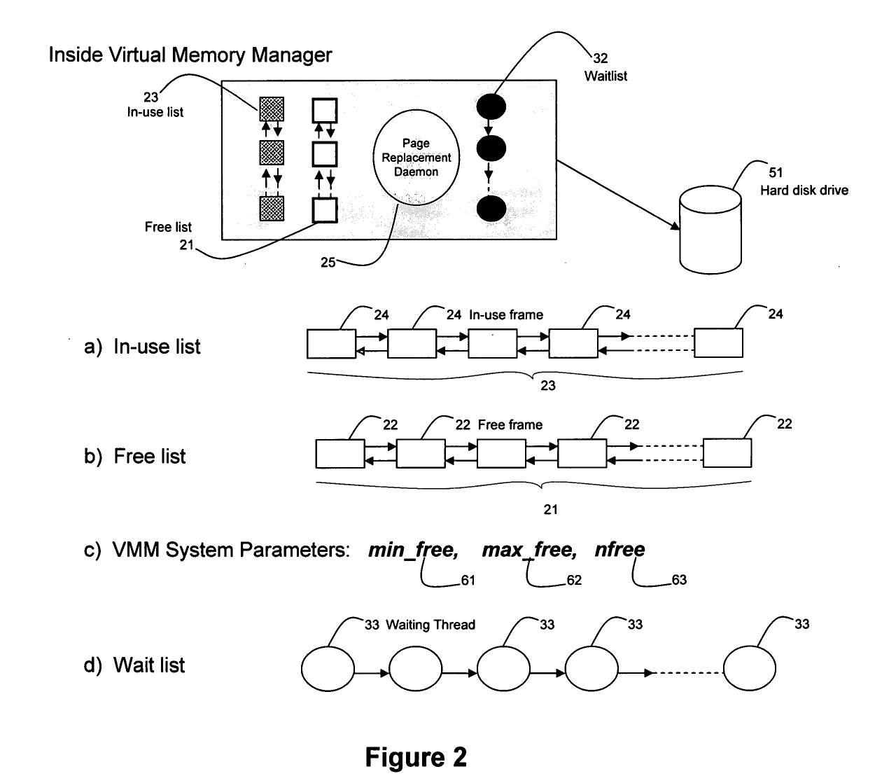

Referring to FIG. 1, a typical operating system kernel 10 consists of several components—Virtual Memory Manager (VMM) 20, Process Manager 30, File systems 40, Networking subsystems 50, etc. File systems 40 provides structured access to the hard disk drive. The Process Manager schedules processes and threads on to processors, while the Networking subsystems allows applications to communicate with other machines or computers. This invention pertains to the virtual memory manager component of the Operating System (OS), and other components are not described in this application because they are well known in the art. FIG. 2 shows some of the data structures that the VMM 20 maintains to manage the system memory. The VMM 20 maintains one or more free lists 21 to keep track of the free page frames 22 in the real memory. VMM 20 also maintains the total number of free frames in a variable nfree 63. When a request for a free page comes, the VMM 20 will check if nfree is >0, and if so, it searches its free lists 21 to get a free page. When the value of nfree 63 goes below a lower threshold value min_free 61, VMM 20 will invoke the Page Replacement daemon (also known as the LRU daemon) 25 to initiate page-out to create a free page frame 22 by evicting the contents of in-use page frames 23 to disk 51. In the embodiment example described in this section, this page-out is implemented by a separate process called the Page Replacement Daemon. The Page Replacement daemon will pageout enough number of page frames such that at the end of its run nfree will be greater than or equal to max_free. All the unfulfilled requests for free page frames are queued onto a waitlist 32 as shown in FIG. 2. The requesting threads 33 are woken up when a free page frame becomes available later.

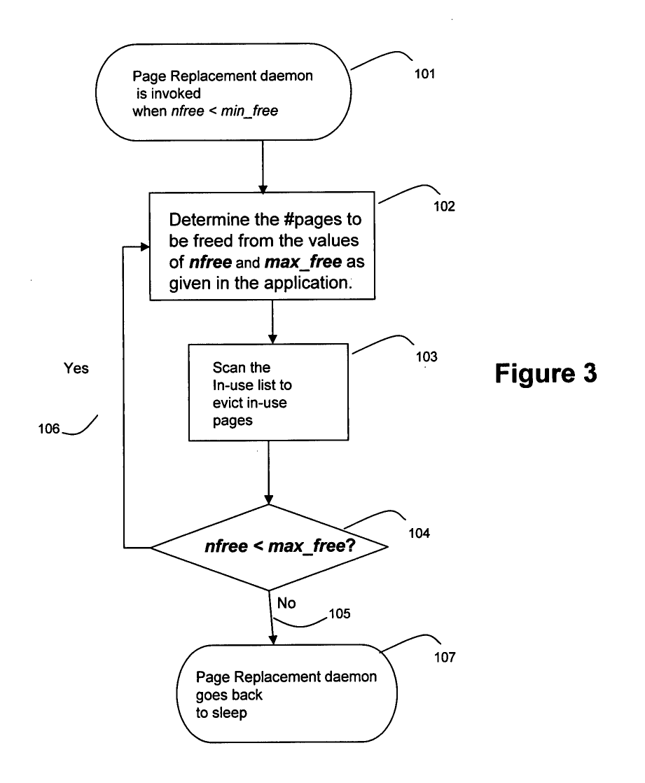

The high level algorithm used by the Page Replacement daemon is shown in FIG. 3. Box 101 represents the invocation of the Page replacement daemon when nfree<min_free. In 102, the Page Replacement daemon calculates the number of pages to be paged out by subtracting nfree 63 from max_free 61. In 103, it scans the in-use page frame list 23 to find appropriate candidates for eviction. Once the Page Replacement daemon starts scanning the memory for selecting candidate pages for eviction, there are several possible policies to decide which particular pages will be paged out. This invention does not depend on any particular policy used for choosing the candidate pages for eviction. After evicting the number of pages as calculated in 102, the Page Replacement daemon checks again whether nfree is still less than max_free in 104. This can happen if page frames are being consumed immediately after they are being freed. If the predicate in 104 evaluates to true, then branch 106 is taken and it re-starts step 102. Otherwise, branch 105 is taken and the Page Replacement daemon goes back to sleep in 107.

Given the above description, it can be observed that the goal of the VMM's Page Replacement daemon is to balance the cost of having too many free page requesters 33 on the waitlist 32 with the cost of evicting too many in-use pages 24 prematurely. This invention addresses this issue by providing mechanisms to determine the optimal values for the parameters min_free 61 and max_free 62 and to adjust these parameters on an ongoing basis as the number of waiters for a free frame change.

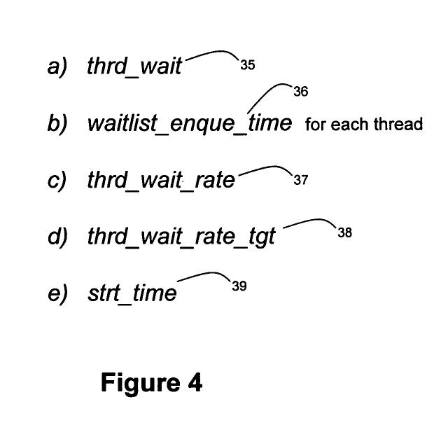

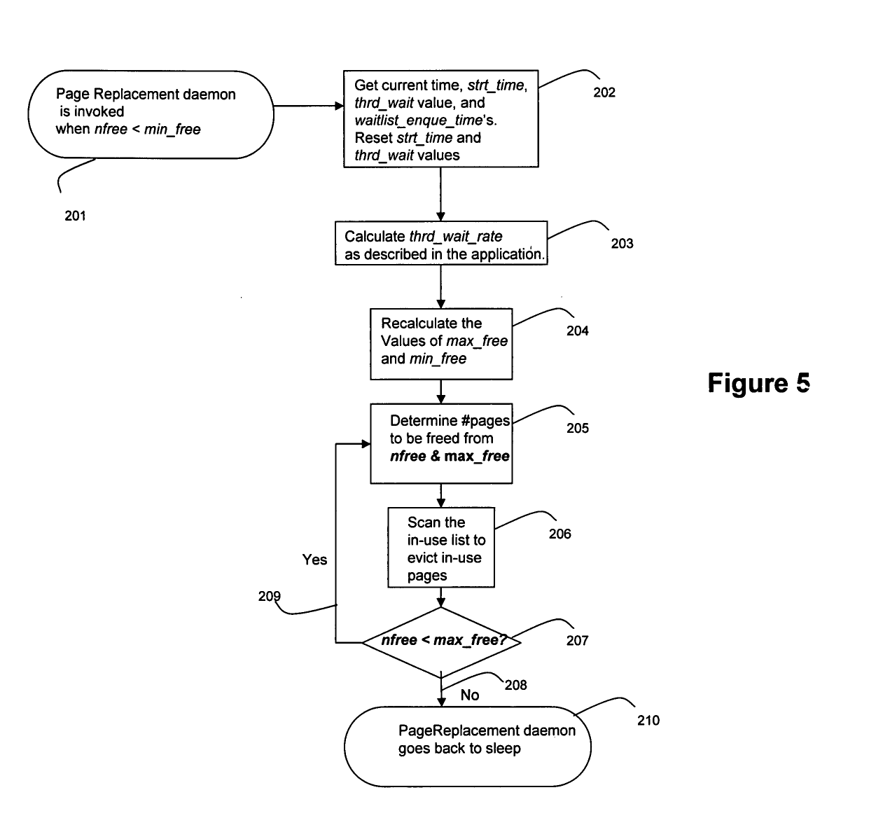

FIG. 4 shows the data structures in the preferred embodiment that are required to implement this invention. We need to continuously monitor the number of requesters and the amount of time each requester spends in the waitlist waiting for a free frame. This is done by maintaining a variable thrd_wait 35. The value of the thrd_wait is updated as follows. Whenever a thread 33 is enqueued on to the waitlist 32, the operating system notes the time at which the thread is enqueued in a per-thread variable waitlist_enque_time 36. When the thread is eventually dequeued as free pages become available, the OS will subtract waitlist_enque_time 36 from the current time to find out the total time the thread has spent in the wait list. The OS will then convert this total time into clock tics, and add it to the thrd_wait 35 counter, which contains the total amount of time in clock tics all the threads together have spent in the wait list. This counter will be reset by the Page Replacement daemon as we will describe in FIG. 5. So the thrd_wait 35 counter contains the total waiting time for all the threads that were enqueued to, and later dequeued from, the waitlist at some point between two runs of the Page Replacement daemon. The Page Replacement daemon maintains another variable thrd_wait_rate 37, which is the average number of threads waiting per clock tic. It is maintained in units of counts per clock_tic, so that this value is normalized across systems with different CPU frequencies. The value of thrd_wait_rate 37 is computed each time the Page Replacement daemon is kicked off, as a ratio of the cumulative total amount of time all the threads have spent waiting since the last run and the number of clock tics encompassed between the two runs. The Page Replacement daemon also maintains another variable strt_time 39 used to calculate the number of encompassed clock tics between the two runs mentioned above. Finally, the thrd_wait_rate_tgt 38 value given in FIG. 4 is used by the Page Replacement daemon to calculate by how much the min_free and the max_free have to be changed.

The flow chart given in FIG. 5 summarizes the new behavior of the Page Replacement daemon. Box 201 represents the invocation of the Page Replacement daemon when nfree<min_free. In 202, the Page Replacement daemon calculates the elapsed time since its last run and the total amount of time in clock tics all the threads spent in the waitlist since the last run. The elapsed time is calculated by reading the current system time and subtracting the previously recorded strt_time 38 value. The total amount of time all the threads have waited since the last run, consists of two parts. The first part is the total wait time of the threads that are not currently in the wait list. This is maintained in the thrd_wait counter by the OS. The second part is the total time the threads that are still in wait list have spent in the queue. The Page replacement daemon 25 calculates this second part by walking through the wait list 32, subtracting each thread's waitlist_enque_time 36 from the current time, and summing up all the waiting times. The total waiting time of all threads, either in or out of the wait list, is calculated by adding the above value to the thrd_wait counter 35.

An alternative mechanism to calculate the total waiting time of all threads is to poll the waitlist once every clock tic to count the number of threads in the waitlist, and add it to the thrd_wait counter. In this case the Page Replacement daemon does not have to walk through the wait list at the beginning of each run. The disadvantage is that the OS has to do additional work at every clock tic, which may be too much of overhead.

As the Page Replacement daemon calculates the elapsed time and the total thread waiting time in 202, it also resets the time stamp values strt_time and the per-thread waitlist_enque_time to the current system time immediately after reading those variables. It will also reset thrd_wait_time to 0 so that this counter contains the waiting time for all the threads that will go through the wait list from now on. In 203 the Page Replacement daemon calculates the thrd_wait_rate 36 by dividing the total thread waiting time by the elapsed time. In 204 it re-calculates the min_free 61 and max_free 62 values based on the difference between thrd_wait_rate calculated above and the pre-set target value thrd_wait_rate_tgt, as given below.

The desired min_free value should be increased if the thrd_wait_rate is higher than thrd_wait rate_tgt, and decreased if the thrd_wait_rate is lower than the thrd_wait_rate_tgt. In the embodiment example, the desired min_free is calculated as given below.
desired min_free=min_free*thrd_wait_rate/thrd_wait rate_tgt
The min_free parameter is updated as the average of the desired min_free value and the current value. This averaging provides a bit of damping against oscillations due to spikes in the workload. One can also put an upper limit on the min_free value that can be updated by the Page Replacement daemon, in order to avoid thrashing.

The max_free parameter is updated to maintain the same gap between max_free and min_free as before this update of min_free.

Example: Let us assume that the thrd_wait_rate_tgt is set to 1, thrd_wait_rate is calculated to be 1.5, and min_free & max_free are 120 & 128 respectively. The desired min_free will be 120*1.5/1=180. The Page Replacement daemon will change the min_free to the average of the desired min_free and the current min_free, which is 120+180/2=150. The new value for max_free will be 150+(128−120)=158.

Several alternative mechanisms can be used to calculate the desired min_free value from the deviation in thrd_wait_rate, instead of the simple linear approximation as given above. Any mechansim used to calculate the desired min_free value should adhere to the general principle that min_free should be increased if thrd_wait_rate>thrd_wait_rate_tgt, and decreased if thrd_wait_rate<thrd_wait_rate_tgt.

After re-calculating the min_free and max_free values, the rest of the steps for the Page Replacement daemon—205, 206, 207, 208, 209, and 210—are similar to the steps in FIG. 3-102, 103, 104, 105, 106, and 107—respectively. More specifically, in 205, the Page Replacement daemon calculates the number of pages to be paged out by subtracting nfree 63 from max_free 61. In 206, it scans the in-use page frame list to find appropriate candidates for eviction. Once the Page Replacement daemon starts scanning the memory for selecting candidate pages for eviction, there are several possible policies to decide which particular pages will be paged out. This invention does not depend on any particular policy used for choosing the candidate pages for eviction. After evicting the number of pages as calculated in 205, the Page Replacement daemon checks again whether nfree is still less than max_free in 207. This can happen if page frames are being consumed immediately after they are being freed. If the predicate in 207 evaluates to true, then branch 209 is taken and step 205 starts again. Otherwise, branch 208 is taken and the Page Replacement daemon goes back to sleep in 210.

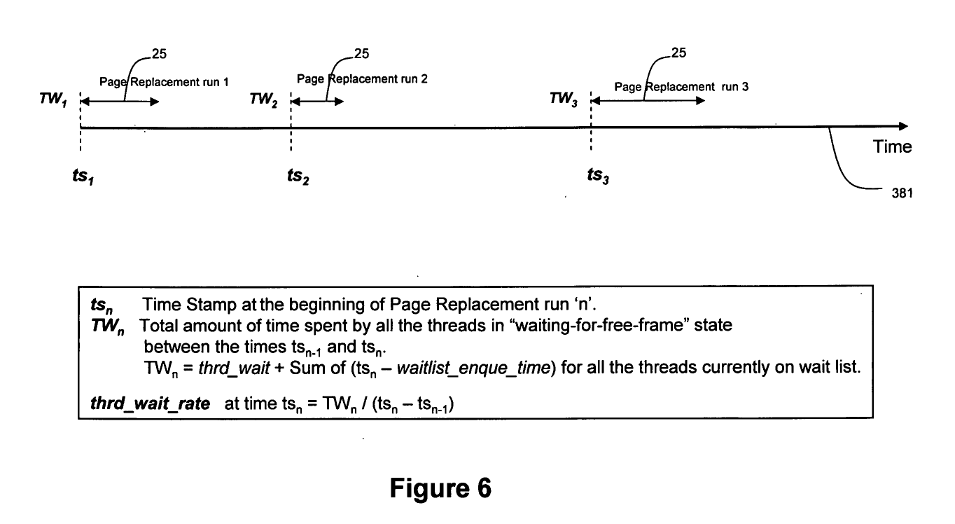

FIG. 6 illustrates with the help of a timeline, how the thrd_wait_rate is calculated.

The arrow 381 serves as a reference line for the wall clock time. On 381, the 3 time stamps ts₁, ts₂, and ts₃ represent the beginning of 3 runs of the Page Replacement daemon. The double-headed arrows shown about the time axis represent the amount of time each run of the Page Replacement daemon 25 took to complete. It can be observed from the figure that each run of the Page Replacement daemon takes a different amount of time to complete. Also, the elapsed time between 2 consecutive instances of the Page Replacement daemon is not fixed. The TWₙ value at each time stamp represents the total amount of time all the threads spent in the wait queue since the last run of the Page Replacement daemon. The TWₙ value is calculated using the thrd_wait counter and the waitlist_enque_time of each thread in the wait list, as described in the earlier paragraph.

In the embodiment example, various parameters are to be initialized at System Initialization time as given below:
min_free 61 and max_free 62 are set to some default values.
thrd_wait counter 35 and thrd_wait_rate 37 are initialized to 0
thrd_wait_rate_tgt 38 is initialized to a certain value, and
strt_time 39 is initialized to the current time.

It should be noted that one can implement the invention even without maintaining a precise thrd_wait_rate value as described in the emodiment example above. In the preferred embodiment described in this application, Page Replacement daemon calculates the precise value thrd_wait_rate by walking through the entire waitlist each time it is invoked. One can also implement this invention by calculating a rough estimate of the thrd_wait_rate, which can reduce the complexity of implementation without significantly reducing the impact on memory availability. In the following paragraphs we describe a couple of alternatives to calculate the thrd_wait_rate.

1) The system can maintain 2 variables nthrds_waited, and nthrds_waiting in addition to the thrd_wait counter. nthrds_waited will contain the number of threads that have contributed to the value in thrd_wait. nthrds_waiting will contain the number of threads currently in the waitlist. Both of these variables are updated whenever a thread is leaving the wait list; nthrds_waiting is also updated when a thread is enqueued onto the waitlist. Given these variables, the Page Replacement daemon can calculate thrd_wait_rate as follows:
thrd_{—}wait_{—}rate=(thrd_{—}wait+((thrd_{—}wait/nthrds_{—}waited)*nthrds_{—}waiting))/(current time−strt_{—}time)
Using this implementation eliminates the need for maintaing waitlist_enque_time for each thread.

2) One can simplify the estimation even further by ignoring the threads that were taken off the wait list. If we ignore the threads that are not currently on the wait list, and assume that the threads on the wait list were enqueued at uniform time intervals, then the thrd_wait_rate can be simply calculated as nthrds_waiting/2. This can be derived as follows.

Assume that the first thread on the wait list was enqueued at time T1, and current time is T2. Since we assume that the threads were enqueued onto the wait list at uniform time intervals, on average each thread is waiting for (T2−T1)/2 amount of time.
Total waiting time of all the threads currently in the wait list=(nthrds_{—}waiting*(T2−T1)/2)
Elapsed time=(T2−T1)thrd_{—}wait_{—}rate=(nthrds_{—}waiting*(T2−T1)/2)/(T2−T1)=nthrds_{—}waiting/2

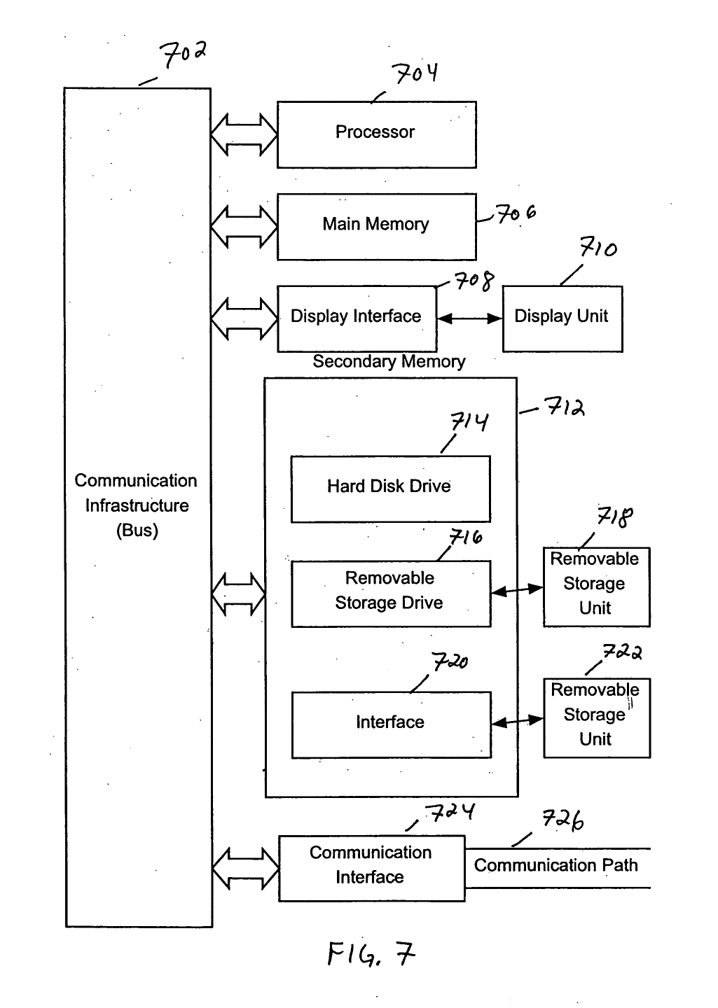

FIG. 7 is a high level block diagram showing an information processing system useful for implementing one embodiment of the present invention. The computer system includes one or more processors, such as processor 704. The processor 704 is connected to a communication infrastructure 702 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 708 that forwards graphics, text, and other data from the communication infrastructure 702 (or from a frame buffer not shown) for display on the display unit 710. The computer system also includes a main memory 706, preferably random access memory (RAM), and may also include a secondary memory 712. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art. Removable storage unit 718, represents a floppy disk, a compact disc, magnetic tape, optical disk, etc. which is read by and written to by removable storage drive 716. As will be appreciated, the removable storage unit 718 includes a computer readable medium having stored therein computer software and/or data.

In alternative embodiments, the secondary memory 712 may include other similar means for allowing computer programs or other instructions to be loaded into the computer system. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system.

The computer system may also include a communications interface 724. Communications interface 724 allows software and data to be transferred between the computer system and external devices. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. These signals are provided to communications interface 724 via a communications path (i.e., channel) 726. This channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 706 and secondary memory 712, removable storage drive 716, a hard disk installed in hard disk drive 714, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allows a computer to read such computer readable information.

Computer programs (also called computer control logic) are stored in main memory 706 and/or secondary memory 712. Computer programs may also be received via communications interface 724. Such computer programs, when executed, enable the computer system to perform the features of the present invention as discussed herein. In particular, the computer programs, when executed, enable the processor 704 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments.

Furthermore, it is intended that the appended claims cover any and all such applications, modifications, and embodiments within the scope of the present invention.

1. A method for managing memory availability in a computer system, said method comprising:
automatically changing a lower threshold of free memory space as a function of memory load; and
making more memory space available when free memory space is below said lower threshold.

2. A method for managing memory availability in a computer system, said method comprising:
automatically changing said lower threshold when a thread wait rate becomes different than a target thread wait rate, said thread wait rate being the average number of threads waiting in a free memory wait list per unit time; and
making more memory space available when free memory space is below said lower threshold.

3. A method as recited in claim 2, wherein said lower threshold is increased when said thread wait rate becomes higher than said target thread wait rate.

4. A method as recited in claim 2, wherein said lower threshold is decreased when said thread wait rate becomes lower than said target thread wait rate.

5. A method as recited in claim 2, wherein a higher threshold is increased when said thread wait rate becomes higher than said target thread wait rate, wherein said higher threshold is used to determine the amount of memory space that will be made available when a page replacement daemon is executed.

6. A method as recited in claim 2, wherein a higher threshold is decreased when said thread wait rate becomes lower than said target thread wait rate, wherein said higher threshold is used to determine the amount of memory space that will be made available when a page replacement daemon is executed.

7. A method as recited in claim 2, wherein said thread wait rate can be calculated by counting the cumulative number of clock tics spent by all the threads that have waited in the free memory wait list and dividing said cumulative number by the total number of clock tics between two successive executions of said page replacement daemon.

8. A method as recited in claim 7, wherein said threads comprise first threads that are currently in said free memory wait list and second threads that were in said free memory wait after the first of said two successive executions of said page replacement daemon, where said second threads are no longer in said free memory wait list.

9. A method as recited in claim 2, wherein said thread wait rate can be calculated by dividing the current number of threads in the free memory wait list by an number.

10. A method as recited in claim 9, wherein said number is the integer two.

11. A method as recited in claim 2, wherein a page replacement daemon is executed when free memory space falls below said lower threshold, wherein said page replacement daemon makes more memory space available.

12. A method as recited in claim 11, wherein said page replacement daemon is executed if the number of free memory frames falls below a lower threshold, and wherein said page replacement daemon comprises freeing a number of frames so that the number of free frames reaches said higher threshold.

13. A program storage device readable by a digital processing apparatus and having a program of instructions which are tangibly embodied on the storage device and which are executable by the processing apparatus to perform a method for managing memory availability in a computer system, said method comprising:
automatically changing a lower threshold of free memory space as a function of memory load; and
making more memory space available when free memory space is below said lower threshold.

14. A apparatus for managing memory availability in a computer system, said apparatus comprising:
means for automatically changing a lower threshold of free memory space as a function of memory load; and
means for making more memory space available when free memory space is below said lower threshold.
